(19) United States
(12) Patent Application Publication
(10) Pub. No.: US 2020/0360992 A1
(43) Pub. Date: Nov. 19, 2020

(54) SPHERICAL TI-BASED POWDER AND MANUFACTURING METHOD THEREFOR

(71) Applicant: HITACHI METALS, LTD., Tokyo (JP)

(72) Inventors: Koichi SAKAMAKI, Tokyo (JP); Kazuya SAITO, Tokyo (JP); Kiyomi NAKAMURA, Tokyo (JP)

(73) Assignee: HITACHI METALS, LTD., Tokyo (JP)

(21) Appl. No.: 16/765,865

(22) PCT Filed: Dec. 4, 2018
(86) PCT No.: PCT/JP2018/044501

§ 371 Date: May 20, 2020

(30) Foreign Application Priority Data
Dec. 18, 2017 (JP) 2017-241302

(51) Int. Cl. B22F 1/00; B22F 9/14; B33Y 70/00

(52) U.S. Cl. CPC B22F 1/0048; B22F 1/0011; B22F 2301/205; B33Y 70/00; B22F 2304/10; B22F 9/14

(57) ABSTRACT

A spherical Ti-based powder and a manufacturing method therefor are provided. The spherical Ti-based powder has a 50% particle size (D50) of 1 to 250 μm in a cumulative particle size distribution based on volume, in which a total amount of oxygen and hydrogen is less than 3000 ppm by mass, an area defect rate in a cross-section of the spherical Ti-based powder is less than 0.100%, and an area circularity of the spherical Ti-based powder in a secondary projection image is 0.90 or more. The spherical Ti-based powder can be obtained by subjecting a pulverized Ti-based powder to a fusion and solidification treatment using a thermal plasma in which a flow rate of hydrogen gas as a working gas is adjusted to less than 0.3 l/min.

### TECHNICAL FIELD

The present invention relates to a spherical Ti-based powder used for three-dimensional additive manufacturing using, for example, an electron beam, a laser beam, or the like, and a method for manufacturing the same.

### BACKGROUND ART

Because Ti-based materials such as Ti and Ti-based alloys have excellent corrosion resistance, ductility, and strength, and are also excellent in terms of being lightweight, they are used in aircraft parts and chemical plant parts. Furthermore, these materials have favorable biocompatibility and therefore have been developed for various usage applications such as medical uses.

In addition, because it is difficult to process and mold from Ti-based materials applied in these usage applications, processing costs are high, and attention has been paid to processing by three-dimensional additive manufacturing, powder injection molding, or the like, which can perform molding of an arbitrary shape into a near net shape for shaped articles such as parts each having different specifications and products having complicated shapes.

In these processing methods, it is required that a Ti-based powder be spherical and fluidity of the powder be ensured for the purpose of improving near net shapability for a shaped article and also improving mechanical strength and reliability. For example, Patent Literature 1 discloses that it is possible to efficiently manufacture a spherical Ti-based powder having high fluidity by pulverizing hydrogen-embrittled and hydrogen-containing Ti-based material to obtain a hydrogen-containing pulverized Ti-based powder, subjecting this hydrogen-containing pulverized Ti-based powder to fusion and solidification by a thermal plasma and to a spheroidization treatment, and thereby obtaining a spherical Ti-based powder containing 0.05 to 3.2 mass % of hydrogen.

In addition, Patent Literature 2 discloses that it is possible to manufacture a Ti-based powder having excellent fluidity and an excellent shape retention capacity in a shaped article by mixing a pulverized Ti-based powder manufactured by a hydrogenation-dehydrogenation method (hereinafter referred to as a “HDH method”) or a pulverization method with a spherical Ti-based powder and a non-spherical Ti-based powder which are obtained by a plasma processing, and performing adjustment so that an average circularity becomes 0.815 or more and less than 0.870, a CV value of a particle size becomes 22 to 30, and an angle of repose becomes 29° to 36°.

### CITATION LIST

### Patent Literature

### [Patent Literature 1]

Japanese Patent Laid-Open No. 2009-287105

### [Patent Literature 2]

PCT International Publication No. WO2016/140064

### SUMMARY OF INVENTION

### Technical Problem

Since the spherical Ti-based powder disclosed in Patent Literature 1 has high fluidity, it is suitable for the above-mentioned three-dimensional additive manufacturing, but because it contains 0.05 to 3.2 mass % of hydrogen, fine pores may be formed inside a shaped article due to hydrogen, and thereby the mechanical strength of the shaped article may be reduced.

In addition, in a case where the spherical Ti-based powder containing 0.05 to 3.2 mass % of hydrogen disclosed in Patent Literature 1 is subjected to a vacuum heat treatment or the like to remove the contained hydrogen, an amount of oxygen in the spherical Ti-based powder may be increased. In a case where additive manufacturing is performed using such a spherical Ti-based powder, an amount of oxides inside in a shaped article may be increased, and thereby the mechanical strength of the shaped article may be reduced.

Furthermore, in a case where the spherical Ti-based powder is subjected to a vacuum heat treatment, sintering and agglomeration of powder particles proceed, and therefore a crushing treatment is required. Accordingly, in addition to a decrease in circularity of the spherical Ti-based powder, an oxide film may be formed on a surface of the spherical Ti-based powder due to frictional heat during the crushing treatment, and thereby the quality of a shaped article may be reduced.

Meanwhile, in the Ti-based powder disclosed in Patent Literature 2, it is possible to secure a shape retention capacity for a shaped article by adjusting an average circularity, a CV value of a particle size, and an angle of repose such that they are within a predetermined range, but in a case where an average circularity is 0.815 or more and less than 0.870, irregularities may be formed on a surface of the Ti-based powder, and thereby fluidity may become non-uniform. This leads to problems of a local deterioration in spreadability and a reduction in shape accuracy of a shaped article in, for example, three-dimensional additive manufacturing represented by a powder bed type.

An objective of the present invention is to solve the above-mentioned problems and provide a spherical Ti-based powder suitable for three-dimensional additive manufacturing and a method for manufacturing the same.

### Solution to Problem

A spherical Ti-based powder of the present invention is a spherical Ti-based powder in which a 50% particle size (D50) is 1 to 250 μm in a cumulative particle size distribution based on volume, a total content of oxygen and hydrogen is less than 3,000 ppm by mass, and an area defect rate in a cross-section of the spherical Ti-based powder is less than 0.100%.

In the spherical Ti-based powder of the present invention, an area circularity of the spherical Ti-based powder in a secondary projection image is preferably 0.90 or more.

In addition, in the spherical Ti-based powder of the present invention, a content of oxygen is preferably 1,000 ppm by mass or less.

The spherical Ti-based powder of the present invention can be obtained by subjecting a pulverized Ti-based powder to a fusion and solidification treatment using a thermal plasma in which a flow rate of hydrogen gas as a working gas is adjusted to less than 0.3 l/min.

### Advantageous Effects of Invention

According to the present invention, it is possible to inhibit formation of fine pores and oxides inside a shaped article during additive manufacturing by controlling a total content of oxygen and hydrogen, and thereby it is possible to improve mechanical strength of the shaped article.

### BRIEF DESCRIPTION OF DRAWINGS

FIG. 1 is a scanning electron microscope image of a spherical Ti-based powder of Present Example 1.

FIG. 2 is a scanning electron microscope image of a spherical Ti-based powder of Present Example 2.

FIG. 3 is a scanning electron microscope image of a spherical Ti-based powder of Present Example 3.

FIG. 4 is a scanning electron microscope image of a spherical Ti-based powder of Comparative Example 1.

FIG. 5 is a scanning electron microscope image of a spherical Ti-based powder of Comparative Example 2.

FIG. 6 is a scanning electron microscope image of a spherical Ti-based powder of Comparative Example 3.

### DESCRIPTION OF EMBODIMENTS

The present invention is characterized in that a total content of oxygen and hydrogen in a spherical Ti-based powder used as a raw material for three-dimensional additive manufacturing is less than 3000 ppm by mass. According to the spherical Ti-based powder of the present invention, it is possible to inhibit generation of oxides that may hinder fusion and sintering by controlling a content of oxygen. In addition, according to the spherical Ti-based powder of the present invention, it is possible to curb risk of re-formation of oxides by reacting with a constituent element such as Ti which is oxidatively active during additive manufacturing, and thereby it is possible to improve mechanical strength of a shaped article to be obtained.

Furthermore, in the spherical Ti-based powder according to one embodiment of the present invention, a content of oxygen is preferably 2,800 ppm by mass or less, more preferably 1,300 ppm by mass or less, even more preferably 1,000 ppm by mass or less, and particularly preferably 980 ppm by mass or less.

Furthermore, by suppressing a content of hydrogen in the spherical Ti-based powder of the present invention, an effect of inhibiting formation of fine pores inside a shaped article to be obtained due to hydrogen is exhibited.

Furthermore, in the spherical Ti-based powder according to one embodiment of the present invention, a content of hydrogen is preferably 150 ppm by mass or less and more preferably 110 ppm by mass or less.

Furthermore, based on the same reason as described above, in the spherical Ti-based powder according to one embodiment of the present invention, a total content of oxygen and hydrogen is preferably 2,000 ppm by mass or less, more preferably 1,500 ppm by mass or less, and even more preferably 1,130 ppm by mass or less.

Furthermore, since Ti is an oxidatively active element, it is extremely difficult to control a total content of oxygen and hydrogen such that it is less than 10 ppm by mass. Accordingly, a total content of oxygen and hydrogen in the spherical Ti-based powder according to one embodiment of the present invention is preferably 20 ppm by mass or more from the viewpoint of manufacturability. A content of oxygen in the spherical Ti-based powder according to one embodiment of the present invention is preferably 10 ppm by mass or more. In addition, a content of hydrogen in the spherical Ti-based powder according to one embodiment of the present invention is preferably 10 ppm by mass or more.

In the spherical Ti-based powder of the present invention, a 50% particle size is 1 to 250 μm in a cumulative particle size distribution based on volume (hereinafter, referred to as a “D50”). In the case where the D50 is 1 μm or more in the spherical Ti-based powder of the present invention, an amount of oxygen adsorbed on a surface of the powder can be reduced, and thereby it is possible to inhibit generation of oxides that may hinder fusion and sintering. In addition, in the case where the D50 is 1 μm or more in the spherical Ti-based powder of the present invention, an influence of moisture and the like in the atmosphere is reduced, and thereby it is possible to secure favorable fluidity.

Furthermore, in the case where the D50 is 250 μm or less in the spherical Ti-based powder of the present invention, and in a case where the powder is applied to, for example, three-dimensional additive manufacturing represented by a powder bed type, spreadability can be improved, and furthermore, favorable fusibility with respect to thermal energy of a laser beam, an electron beam, or the like can be secured, and thereby it is possible to maintain dimensional accuracy of a shaped article.

Furthermore, the cumulative particle size distribution in the spherical Ti-based powder of the present invention is represented by a cumulative volume particle size distribution, and a D50 thereof is represented by a value measured by a laser diffraction scattering method defined in MS Z 8825.

The term “Ti-based” referred to in the present invention refers to pure Ti or a Ti-based alloy containing 50 mass % or more of Ti. Examples of Ti-based alloys include a Ti—Al—V alloy such as Ti-6% Al-4% V (mass %) in which Ti contains 6 mass % of Al and 4 mass % of V, a Ti—Al—Mo—V alloy such as Ti-8% Al-1% Mo-1% V (mass %) in which Ti contains 8 mass % of Al, 1 mass % of Mo, and 1 mass % of V, and the like.

In the spherical Ti-based powder of the present invention, an area defect rate such as pores in a cross-section of the powder is less than 0.100% to inhibit pores formed by an inert gas or the like entrained inside the powder during a granulation process. In addition, based on the same reason as described above, an area defect rate is more preferably 0.070% or less. Thereby, according to the spherical Ti-based powder of the present invention, it is possible to inhibit internal defects in a shaped article being obtained, and to improve mechanical strength.

Although the term cross-section referred to in the present invention in the area defect rate in a cross-section of the powder is ideally a cross-section in which a diameter dividing through the center position of the powder is a particle size, it is not realistic to accurately expose such a cross-section of each of powders. Accordingly, in the present invention, first, a set of spherical Ti-based powders is prepared, and according to the general procedure for producing a sample for microscopic observation, the plurality of powders are roughly arranged on one surface and embedded in a thermosetting resin or the like, and thereafter, the sample is adjusted by buffing with alumina abrasive grains having a particle size of 1 μm.

Then, regarding an area defect rate in the cross-section of the powder, an area of 900 μm×600 μm at five arbitrary cross-sections of the powders on an observation surface of the above adjusted sample is photographed at a magnification of 200 times with an optical microscope. Then, binarization is performed to separate powder cross-section parts from other parts in an image captured using, for example, ImageJ 1.45, which is public domain image processing software.

Using powder particles having an equivalent circle diameter of 1 μm or more and contained in the above-mentioned image as targets, an area ratio of pores in the cross-section is calculated as an area defect rate. That is, an area (A) of a powder image-processed such that it does not include pores and an area (B) of pores are measured, and from 100×B/A, it is possible to calculate an area defect rate (%) in the cross-section of the powder.

If an area circularity of a spherical Ti-based powder falls below 0.90, more irregularities are formed on a surface of a powder, and a kinetic friction force between powders increases, thereby decreasing fluidity. For this reason, uniform spreadability is impaired during additive manufacturing, and defects may be formed inside a shaped article. Accordingly, in the spherical Ti-based powder of the present invention, an area circularity of the powder in a secondary projection image is preferably 0.90 or more and more preferably 0.95 or more. The upper limit value of an area circularity of the spherical Ti-based powder is 1.00.

An area circularity, which is referred to in the present invention, of the powder in a secondary projection image can be obtained by measuring area circularity values of 20,000 powder particles having an equivalent circle diameter of 1 μm or more in a secondary projection image using, for example, an automated static image analyzer Morphologi G3 manufactured by Malvern Instruments, and calculating an average value thereof.

The spherical Ti-based powder of the present invention can be manufactured by, for example, an inert gas induction and dissolved gas atomization method, a wire plasma atomization method, a rotating electrode method, or the like.

However, in a spherical Ti-based powder manufactured by the inert gas induction and dissolved gas atomization method, when a fused metal is pulverized with an inert gas such as Ar, the inert gas may be entrained inside the powder, and thereby pores may be formed inside the powder in some cases. In addition, in the case of the inert gas induction and dissolved gas atomization method, when a fused metal is pulverized, fine particles of about 1 to 10 μm may adhere to surfaces of powders of 50 μm or more, and thereby the area circularity may be decreased in some cases.

On the other hand, these problems of the inert gas induction and dissolved gas atomization method may be solved by the wire plasma atomization method and the rotating electrode method.

However, in the wire plasma atomization method, it is necessary to manufacture a Ti-based fine wire having a diameter of 1 mm or less. In addition, in the rotating electrode method, it is necessary to manufacture a columnar Ti-based electrode having a diameter of about 100 mm. Accordingly, these manufacturing methods increase costs and the number of processes of operation as compared to the inert gas induction and dissolved gas atomization method.

The spherical Ti-based powder can also be obtained by a fusion and solidification treatment using a thermal plasma. In the fusion and solidification treatment using a thermal plasma, in general, an energy density of the thermal plasma is increased, and 1.0 l/min or more of hydrogen gas, which is a diatomic molecule having the lowest molecular weight, is used as a working gas for the purpose of inhibiting oxidation of a powder to be obtained. In a case where a pulverized Ti-based powder in which a content of hydrogen has been adjusted by the above-mentioned HDH method or the like is spheroidized in conditions in which hydrogen gas is used as a working gas, 500 ppm by mass or more of hydrogen is occluded in the spherical Ti-based powder, and thereby it becomes difficult to control a total content of oxygen and hydrogen such that it is less than 3000 ppm by mass.

In addition, in a case where hydrogen contained in the spherical Ti-based powder is removed by a vacuum heat treatment or the like, an amount of oxygen in the spherical Ti-based powder may be increased, which increases an amount of oxides inside a shaped article, and thereby the mechanical strength of the shaped article may be reduced in some cases. Furthermore, in a case where the spherical Ti-based powder obtained above is subjected to a vacuum heat treatment, sintering and agglomeration of powder particles proceed, and therefore a crushing treatment is required. For this reason, in addition to decrease in circularity of the spherical Ti-based powder, an oxide film may be formed on a surface of the spherical Ti-based powder due to frictional heat during the crushing treatment, and thereby the quality of a shaped article may be reduced.

In a method for manufacturing a spherical Ti-based powder of the present invention, first, a pulverized Ti-based powder manufactured by adjusting a content of hydrogen in advance by the HDH method is prepared as a raw material powder. Then, the above-mentioned pulverized Ti-based powder is subjected to a fusion and solidification treatment using a thermal plasma in which hydrogen gas is not used, that is, a thermal plasma in which a flow rate of hydrogen gas as a working gas is limited to being less than 0.3 l/min, and thereby a spherical Ti-based powder is obtained.

In the spherical Ti-based powder obtained by the manufacturing method of the present invention, it is possible to promote spheroidization, that is, increase an area circularity and also reduce an amount of hydrogen occluded. For this reason, in the manufacturing method of the present invention, it is not necessary to perform a vacuum heat treatment after the above-mentioned fusion and solidification treatment, and the accompanying crushing treatment and the like.

In addition, the manufacturing method of the present invention enables inhibition of agglomeration of powder particles in addition to controlling of a total content of oxygen and hydrogen in the obtained spherical Ti-based powder such that it is less than 3000 ppm by mass. Furthermore, based on the same reason as described above, the spherical Ti-based powder of the present invention is preferably obtained by the fusion and solidification treatment using a thermal plasma in which a flow rate of hydrogen gas as a working gas is limited to 0.2 l/min or less, and where a flow rate of hydrogen gas is more preferably 0.1 l/min or less.

Furthermore, a plasma output of the thermal plasma is preferably 20 kW or less. Thereby, it is possible to manufacture a spherical Ti-based powder in which an area defect rate in a cross-section of the powder is less than 0.1%, and an area circularity of the powder in a secondary projection image is 0.9 or more.

Furthermore, it is preferable to adjust a content of hydrogen in a pulverized Ti-based powder to 300 ppm by mass or less to obtain the spherical Ti-based powder of the present invention. Furthermore, a content of oxygen in the pulverized Ti-based powder is preferably adjusted to 2,700 ppm by mass or less, is more preferably adjusted to 1,000 ppm by mass or less, and is even more preferably adjusted to 950 ppm by mass or less.

### EXAMPLES

Cutting chips collected from a Ti-6% Al-4% V (mass %) ingot were pulverized by a HDH method and classified into a particle size range of 45 to 150 μm by sieving, and thereby a pulverized Ti-based powder was prepared. The pulverized Ti-based powder was adjusted so that a total content of oxygen and hydrogen became 2,750 ppm by mass.

In a thermal plasma flame generated by supplying only Ar gas as a working gas at a flow rate of 76 l/min at a plasma output of 15 kW, the above-mentioned pulverized Ti-based powder was supplied at a supply rate of 100 g/hr using Ar gas as a carrier gas at a flow rate of 4 l/min to be spheroidized by a fusion and solidification treatment using a thermal plasma. The powder was classified by sieving, and thereby a spherical Ti-based powder having a D50 of 80 μm was obtained as Present Example 1.

Cutting chips collected from a 100% Ti (mass %) ingot were pulverized by a HDH method and classified into a particle size range of 45 to 150 μm by sieving, and thereby a pulverized Ti-based powder was prepared. The pulverized Ti-based powder was adjusted so that a content of oxygen became 779 ppm by mass and a content of hydrogen became 212 ppm by mass, that is, a total content of oxygen and hydrogen became 991 ppm by mass.

In a thermal plasma flame generated by supplying only Ar gas as a working gas at a flow rate of 76 l/min at a plasma output of 15 kW, the above-mentioned pulverized Ti-based powder was supplied at a supply rate of 100 g/hr using Ar gas as a carrier gas at a flow rate of 4 l/min to be spheroidized by a fusion and solidification treatment using a thermal plasma. The powder was classified by sieving, and thereby a spherical Ti-based powder having a D50 of 92 μm was obtained as Present Example 2.

Cutting chips collected from a 100% Ti (mass %) ingot were pulverized by the HDH method and classified into a particle size range of 45 to 150 μm by sieving, and thereby a pulverized Ti-based powder was prepared. The pulverized Ti-based powder was adjusted so that a content of oxygen became 1,087 ppm by mass and a content of hydrogen became 231 ppm by mass, that is, a total content of oxygen and hydrogen became 1,318 ppm by mass.

In a thermal plasma flame generated by supplying only Ar gas as a working gas at a flow rate of 76 l/min at a plasma output of 15 kW, the above-mentioned pulverized Ti-based powder was supplied at a supply rate of 100 g/hr using Ar gas as a carrier gas at a flow rate of 4 l/min to be spheroidized by a fusion and solidification treatment using a thermal plasma. The powder was classified by sieving, and thereby a spherical Ti-based powder having a D50 of 68 μm was obtained as Present Example 3.

A pulverized Ti-based powder was prepared in the same manner as in Present Example 1. In a thermal plasma flame generated by supplying Ar gas at a flow rate of 86l/min and hydrogen gas at a flow rate of 0.3 l/min as working gases at the same time at a plasma output of 15 kW, the above-mentioned pulverized Ti-based powder was supplied at a supply rate of 100 g/hr using Ar gas as a carrier gas at a flow rate of 4 l/min to be spheroidized by a fusion and solidification treatment using a thermal plasma. The powder was classified by sieving, and thereby a spherical Ti-based powder having a D50 of 71 μm was obtained as Comparative Example 1.

The spherical Ti-based powder of Comparative Example 1 was subjected to a vacuum heat treatment in a vacuum atmosphere of 2.5×10⁻³ Pa under conditions of a temperature of 700° C. and a heating and retention time of 1 hour, and thereby hydrogen contained in the spherical Ti-based powder was removed. Thereafter, the powder was subjected to a crushing treatment by a ball mill for 10 minutes and classified by sieving, and thereby a spherical Ti-based powder having a D50 of 72 μm was obtained as Comparative Example 2.

A pulverized Ti-based powder was prepared in the same manner as in Present Example 3. In a thermal plasma flame generated by supplying Ar gas at a flow rate of 86l/min and hydrogen gas at a flow rate of 0.3 l/min as working gases at the same time at a plasma output of 15 kW, the above-mentioned pulverized Ti-based powder was supplied at a supply rate of 100 g/hr using Ar gas as a carrier gas at a flow rate of 4 l/min to be spheroidized by a fusion and solidification treatment using a thermal plasma. The powder was classified by sieving, and thereby a spherical Ti-based powder having a D50 of 74 μm was obtained as Comparative Example 3.

For each of the above obtained spherical Ti-based powders of the present examples and the comparative examples, Al and V were analyzed by ICP emission spectroscopy, oxygen was analyzed by an inert gas fusion-infrared absorption method, and hydrogen was analyzed by a fusion-thermal conductivity method. In addition, a D50 of each of the spherical Ti-based powders was measured by a laser diffraction and scattering type particle size distribution measuring device MT3000 manufactured by MicrotracBEL Corp. The results are shown in Table 1.

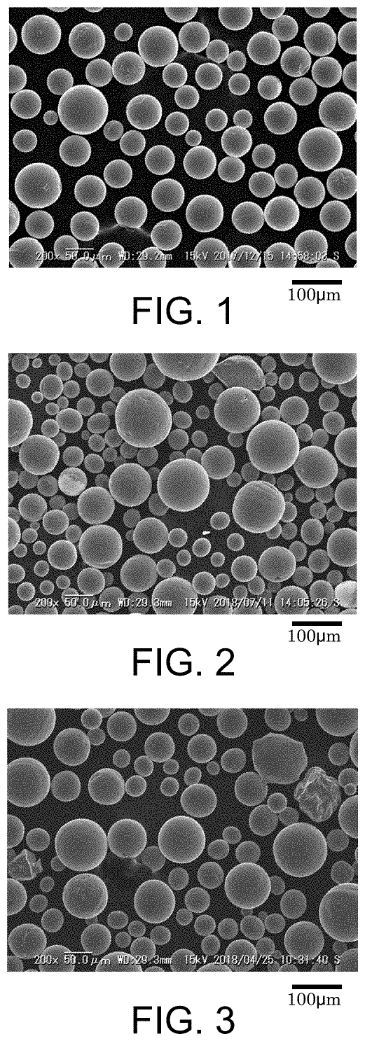

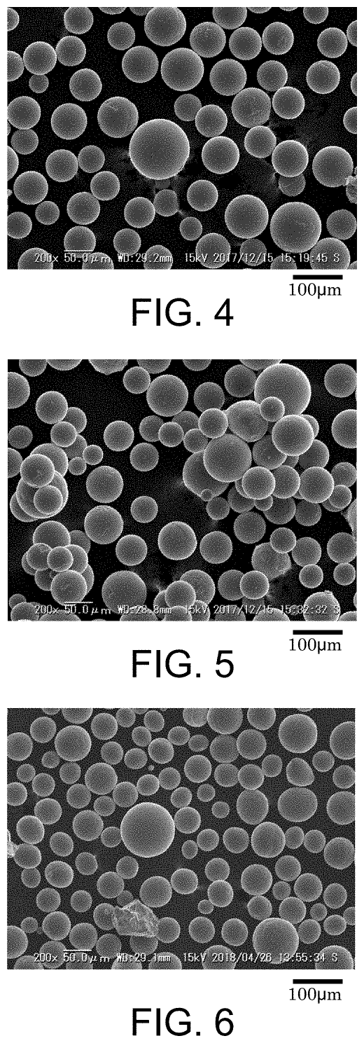

Furthermore, the appearance of each of the spherical Ti-based powders was photographed at a magnification of 200 times with a simple scanning electron microscope VE-8800 manufactured by KEYENCE CORPORATION. The results are shown in FIGS. 1 to 6.

As shown in FIGS. 1 to 4 and 6, in Present Examples 1 to 3 and Comparative Examples 1 and 3 which were subjected to the fusion and solidification treatment by a thermal plasma, favorable sphericity was shown, and fluidity was high because the powder particles were isolated from each other.

On the other hand, as shown in FIG. 5, in the powder of Comparative Example 2, which was subjected to a vacuum heat treatment and a crushing treatment after a fusion and solidification treatment by a thermal plasma, sintered and agglomerated spherical Ti-based powder particles could not be completely crushed, and agglomerated powder parts were formed in part of the spherical Ti-based powder, meaning that the fluidity deteriorated.

TABLE 1

| | Ti | Al | V | O | H | O + H | D50 |
|---|---|---|---|---|---|---|---|
| | Mass % | | | ppm by mass | | | μm |
| Present | Bal. | 6.09 | 4.38 | 2720 | 76 | 2796 | 80 |
| Example 1 | | | | | | | |
| Present | Bal. | — | — | 823 | 120 | 943 | 92 |
| Example 2 | | | | | | | |
| Present | Bal. | — | — | 1261 | 106 | 1367 | 68 |
| Example 3 | | | | | | | |
| Comparative | Bal. | 5.70 | 4.31 | 1836 | 2076 | 3912 | 71 |
| Example 1 | | | | | | | |
| Comparative | Bal. | 5.70 | 4.31 | 3000 | 7 | 3007 | 72 |
| Example 2 | | | | | | | |
| Comparative | Bal. | — | — | 1400 | 3289 | 4689 | 74 |
| Example 3 | | | | | | | |

Based on the results in Table 1, in all of the spherical Ti-based powders of the comparative examples, a total content of oxygen and hydrogen was more than 3000 ppm by mass.

On the other hand, in all of the spherical Ti-based powders of the present examples, a total content of oxygen and hydrogen was less than 3000 ppm by mass, and it could be confirmed that these powders were useful spherical Ti-based powders that can inhibit generation of fine pores and oxides inside a shaped article.

The spherical Ti-based powders of the present examples and comparative examples were roughly arranged on one surface and embedded in a thermosetting resin or the like, and thereafter, the samples were adjusted by buffing with alumina abrasive grains having a particle size of 1 μm to measure an area defect rate in a cross-section of each of the spherical Ti-based powders.

For each of the samples, a visual field of 900 μm×600 μm at five positions was photographed at a magnification of 200 times with an inverted metallurgical microscope GX71 manufactured by Olympus Corporation. Then, binarization was performed to separate powder cross-section parts from other parts in an image captured using ImageJ 1.45, which is public domain image processing software.

Using powder particles having an equivalent circle diameter of 1 μm or more and contained in the above-mentioned image as targets, an area ratio of pores in the cross-section was calculated as an area defect rate. That is, an area (A) of a powder image-processed such that it did not include pores and an area (B) of pores were measured, and from 100×B/A, it was possible to calculate an area defect rate (%) in the cross-section of the powder. The results are shown in Table 2.

In all of the spherical Ti-based powders of the present examples, an area defect rate in a cross-section of the power was less than 0.100%, and it could be confirmed that these powders were useful spherical Ti-based powders that can inhibit formation of fine pores inside a shaped article during additive manufacturing.

An area circularity of each of the spherical Ti-based powders of the present examples in a secondary projection image was obtained by measuring area circularity values of 20,000 powder particles having an equivalent circle diameter of 1 μm or more in a secondary projection image using an automated static image analyzer Morphologi G3 manufactured by Malvern Instruments, and calculating an average value thereof. The results are shown in Table 2.

As a result, it could be confirmed that the spherical Ti-based powders of the present examples were useful spherical Ti-based powders in which an area circularity was 0.90 or more, and uniform spreadability could be ensured during additive manufacturing.

TABLE 2

| | Area defect rate % | Area circularity |
|---|---|---|
| Present Example 1 | 0.057 | 0.96 |
| Present Example 2 | 0.040 | 0.92 |
| Present Example 3 | 0.062 | 0.96 |
| Comparative Example 1 | 0.083 | 0.97 |
| Comparative Example 2 | 0.046 | 0.87 |
| Comparative Example 3 | 0.040 | 0.94 |

1. A spherical Ti-based powder,
wherein a 50% particle size (D50) is 1 to 250 μm in a cumulative particle size distribution based on volume,
a total content of oxygen and hydrogen is less than 3,000 ppm by mass, and
an area defect rate in a cross-section of the spherical Ti-based powder is less than 0.100%.

2. The spherical Ti-based powder according to claim 1, wherein an area circularity of the spherical Ti-based powder in a secondary projection image is 0.90 or more.

3. The spherical Ti-based powder according to claim 1, wherein a content of oxygen is 1,000 ppm by mass or less.

4. A method for manufacturing a spherical Ti-based powder, the method comprising subjecting a pulverized Ti-based powder to a fusion and solidification treatment using a thermal plasma in which a flow rate of hydrogen gas as a working gas is adjusted to less than 0.3 l/min.

5. The spherical Ti-based powder according to claim 2, wherein a content of oxygen is 1,000 ppm by mass or less.
